(19) United States
(12) Patent Application Publication
(10) Pub. No.: US 2017/0118140 A1
(43) Pub. Date: Apr. 27, 2017

(54) NETWORK SWITCH HAVING IDENTICAL DIES AND INTERCONNECTION NETWORK PACKAGED IN SAME PACKAGE

(71) Applicant: MEDIATEK INC., Hsin-Chu (TW)

(72) Inventor: Kuo-Cheng Lu, Hsinchu City (TW)

(21) Appl. No.: 15/191,515

(22) Filed: Jun. 23, 2016

Related U.S. Application Data
(60) Provisional application No. 62/244,718, filed on Oct. 21, 2015.

(51) Int. Cl. H04L 12/933; H04L 12/741; H04L 12/947

(52) U.S. Cl. CPC H04L 49/15; H04L 49/25; H04L 45/745

(57) ABSTRACT

A network switch includes a plurality of identical dies and an interconnection network packaged in a package. The identical dies include at least a first die and a second die, each having a plurality of ingress ports used to receive ingress packets, an ingress packet processing circuit used to process the ingress packets, and a traffic manager circuit used to store packets processed by ingress packet processing circuits of the first die and the second die. The interconnection network is used to transmit an output of the ingress packet processing circuit in the first die to the traffic manager circuit of the second die, and transmit an output of the ingress packet processing circuit of the second die to the traffic manager circuit of the first die.

### CROSS REFERENCE TO RELATED APPLICATIONS

This application claims the benefit of U.S. provisional application No. 62/244,718, filed on Oct. 21, 2015 and incorporated herein by reference.

### BACKGROUND

The present invention relates to a network switch design, and more particularly, to a network switch having identical dies and an interconnection network packaged in the same package.

When a chip function of a target chip is achieved using a large-sized die, the fabrication of large-sized dies on a wafer will suffer from low yield and high cost. For example, assuming that distribution of defects on a wafer is the same, a die yield of large-sized dies fabricated on the wafer is lower than a die yield of small-sized dies fabricated on the same wafer. In other words, the die yield loss is positively correlated to the die size. If the network switch chips are fabricated using large-sized dies, the production cost of the network switch chips is high due to the high die yield loss. Thus, there is a need for an innovative integrated circuit design which is capable of reducing the yield loss as well as the production cost.

### SUMMARY

One of the objectives of the claimed invention is to provide a network switch having identical dies and an interconnection network packaged in the same package.

According to a first aspect of the present invention, an exemplary network switch is disclosed. The exemplary network switch includes a plurality of identical dies and an interconnection network packaged in a package. The identical dies include at least a first die and a second die, each having a plurality of ingress ports arranged to receive ingress packets, an ingress packet processing circuit arranged to process the ingress packets, and a traffic manager circuit arranged to store packets processed by ingress packet processing circuits of the first die and the second die. The interconnection network is arranged to transmit an output of the ingress packet processing circuit in the first die to the traffic manager circuit of the second die, and transmit an output of the ingress packet processing circuit of the second die to the traffic manager circuit of the first die.

According to a second aspect of the present invention, an exemplary network switch is disclosed. The exemplary network switch includes a plurality of identical dies and an interconnection network packaged in a package. The identical dies include at least a first die and a second die, each having a plurality of egress ports arranged to output egress packets, an egress packet processing circuit arranged to generate the egress packets, and a traffic manager circuit arranged to output stored packets to egress packet processing circuits of the first die and the second die. The interconnection network is arranged to transmit an output of the traffic manager circuit of the first die to the egress packet processing circuit of the second die, and transmit an output of the traffic manager circuit of the second die to the egress packet processing circuit of the first die.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first network switch according to an embodiment of the present invention.

FIG. 2 is a diagram illustrating a first ingress packet processing look-up table according to an embodiment of the present invention.

FIG. 3 is a diagram illustrating a second ingress packet processing look-up table according to an embodiment of the present invention.

FIG. 4 is a diagram illustrating a first egress packet processing look-up table according to an embodiment of the present invention.

FIG. 5 is a diagram illustrating a second egress packet processing look-up table according to an embodiment of the present invention.

FIG. 6 is a diagram illustrating a second network switch according to an embodiment of the present invention.

FIG. 7 is a diagram illustrating a third network switch according to an embodiment of the present invention.

FIG. 8 is a diagram illustrating a fourth network switch according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The present invention proposes a network switch that is an integrated circuit (IC) formed by packaging a plurality of identical dies in the same package. Given the same die area, the yield of one large die is lower than the yield of multiple small dies. For example, assuming that distribution of defects on a wafer is the same, a die yield of one large-sized die fabricated on the wafer is lower than a die yield of multiple small-sized dies which have the same area fabricated on the same wafer. Since the fabrication of large-sized dies on a wafer suffers from low yield and high cost, the present invention therefore proposes splitting a network switch IC design into a plurality of identical circuit designs, and fabricating a plurality of smaller-sized dies, each having the same circuit design, on a wafer. Wafer-level packaging is the technology of packaging dies, which is different from a typical packaging method of slicing a wafer into individual dies and then packaging the individual dies. The present invention further proposes generating one network switch IC by packaging a plurality of identical dies in a wafer-level package that is fabricated based on wafer-level process. That is, identical dies (also called homogeneous dies) assembled in the same wafer-level package and interconnection paths routed between the identical dies are fabricated with wafer-level process. Hence, interconnection paths between identical dies could be implemented by metal layer (such as RDL (Re-Distribution) metal layer that makes the I/O pads of an integrated circuit available in other locations) rather than bonding wire of the typical package. By way of example, but not limitation, a wafer-level package used for packaging identical dies of any exemplary network switch proposed by the present invention may be an integrated fan-out (InFO) package or a chip on wafer on substrate (CoWoS) package. Several exemplary network switch designs implemented using multiple identical dies packaged in the same package (e.g., InFO package or CoWos package) are detailed as below.

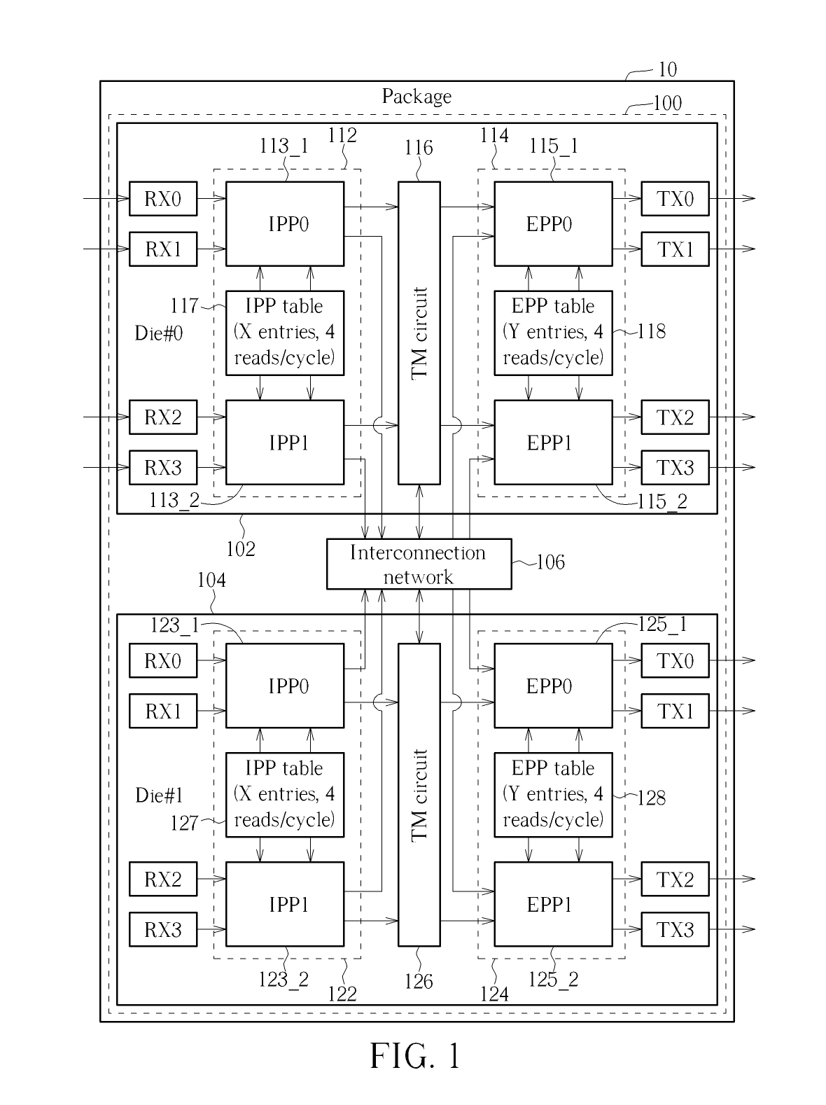

FIG. 1 is a diagram illustrating a first network switch according to an embodiment of the present invention. The network switch 100 includes a plurality of identical dies (e.g., a first die 102 (also denoted by “Die#0”) and a second die 104 (also denoted by “Die#1”)) and an interconnection network 106 packaged in the same package 10. The interconnection network 106 is composed of a plurality of interconnection paths (not shown) connected between the first die 102 and the second die 104. For example, the interconnection paths may be routed on an RDL layer. Therefore, the first die 102 and the second die 104 can communication with each other via the interconnection network 106.

With regard to the first die 102, it includes a plurality of ingress ports (e.g., four ingress ports RX0, RX1, RX2, RX3), a plurality of egress ports (e.g., four egress ports TX0, TX1, TX2, TX3), an ingress packet processing circuit 112, an egress packet processing circuit 114, and a traffic manager (TM) circuit 116. The TM circuit 116 may include packet buffers and a scheduler, where one packet buffer may store packets to be forwarded to one egress port, and the scheduler may decide which packet buffer is allowed to output one or more stored packets. In this embodiment, the ingress packet processing circuit 112 includes a plurality of ingress packet processors (e.g., ingress packet processor 113_1 (also denoted by “IPP0”) and ingress packet processor 113_2 (also denoted by “IPP1”)) and an ingress packet processing look-up table (also denoted by “IPP table”) 117; and the egress packet processing circuit 114 includes a plurality of egress packet processors (e.g., egress packet processor 115_1 (also denoted by “EPP0”) and egress packet processor 115_2 (also denoted by EPP1)) and an egress packet processing look-up table (also denoted by “EPP table”) 118.

Since the second die 104 is identical to the first die 102, the second die 104 also includes a plurality of ingress ports (e.g., four ingress ports RX0, RX1, RX2, RX3), a plurality of egress ports (e.g., four egress ports TX0, TX1, TX2, TX3), an ingress packet processing circuit 122, an egress packet processing circuit 124, and a TM circuit 126. Similarly, the TM circuit 126 may include packet buffers and a scheduler, where one packet buffer may store packets to be forwarded to one egress port, and the scheduler may decide which packet buffer is allowed to output one or more stored packets. In this embodiment, the ingress packet processing circuit 122 includes a plurality of ingress packet processors (e.g., ingress packet processor 123_1 (also denoted by “IPP0”) and ingress packet processor 123_2 (also denoted by “IPP1”)) and an ingress packet processing look-up table (also denoted by “IPP table”) 127; and the egress packet processing circuit 124 includes a plurality of egress packet processors (e.g., egress packet processor 125_1 (also denoted by “EPP0”) and egress packet processor 125_2 (also denoted by EPP1)) and an egress packet processing look-up table (also denoted by “EPP table”) 128.

The ingress packet processing circuit 112 is used to process ingress packets received by the ingress ports RX0-RX3 of the first die 102. In this embodiment, one ingress packet processor 113_1 is used to process ingress packets received from two ingress ports RX0 and RX1 of the first die 102, and the other ingress packet processor 113_2 is used to process ingress packets received from two ingress ports RX2 and RX3 of the first die 102. When an ingress packet is received by one of the ingress ports RX0 and RX1, the ingress packet processors 113_1 is operative to check a packet header of the received ingress packet with pre-defined rules (e.g., forwarding rules) stored in the ingress packet processing look-up table 117 to thereby make the forwarding decision for the received ingress packet. Once the forwarding decision making is done, the ingress packet processor 113_1 writes the received ingress packet into one or both of the TM circuits 116 and 126, depending upon the actual design. For example, when the received ingress packet is a unicast packet, the ingress packet processor 113_1 may write the received ingress packet into a packet buffer in the TM circuit 116, or may write the received ingress packet into a packet buffer in the TM circuit 126 via the interconnection network 106. For another example, when the received ingress packet is a multicast packet, the ingress packet processor 113_1 may write the received ingress packet into a packet buffer in the TM circuit 116, and/or write the received ingress packet into a packet buffer in the TM circuit 126 via the interconnection network 106.

When an ingress packet is received by one of the ingress ports RX2 and RX3, the ingress packet processors 113_2 is operative to check a packet header of the received ingress packet with pre-defined rules (e.g., forwarding rules) stored in the ingress packet processing look-up table 117 to thereby make the forwarding decision for the received ingress packet. Once the forwarding decision making is done, the ingress packet processor 113_2 writes the received ingress packet into one or both of the TM circuits 116 and 126, depending upon the forwarding decision. The ingress packet processors 113_1 and 113_2 have the same ingress packet processing function. For example, when the received ingress packet is a unicast packet, the ingress packet processor 113_2 may write the received ingress packet into a packet buffer in the TM circuit 116, or may write the received ingress packet into a packet buffer in the TM circuit 126 via the interconnection network 106. When the received ingress packet is a multicast packet, the ingress packet processor 113_2 may write the received ingress packet into a packet buffer in the TM circuit 116, and/or write the received ingress packet into a packet buffer in the TM circuit 126 via the interconnection network 106.

Similarly, the ingress packet processing circuit 122 is used to process ingress packets received by the ingress ports RX0-RX3 of the second die 104. In this embodiment, the ingress packet processor 123_1 is used to process ingress packets received from two ingress ports RX0 and RX1 of the second die 104, and the ingress packet processor 123_2 is used to process ingress packets received from two ingress ports RX2 and RX3 of the second die 104. When an ingress packet is received by one of the ingress ports RX0 and RX1 of the second die 104, the ingress packet processors 123_1 is operative to check a packet header of the received ingress packet with pre-defined rules (e.g., forwarding rules) stored in the ingress packet processing look-up table 127 to thereby make the forwarding decision for the received ingress packet. Once the forwarding decision making is done, the ingress packet processor 123_1 writes the received ingress packet into one or both of the TM circuits 116 and 126, depending upon the actual design.

Similarly, when an ingress packet is received by one of the ingress ports RX2 and RX3 of the second die 104, the ingress packet processors 123_2 is operative to check a packet header of the received ingress packet with pre-defined rules (e.g., forwarding rules) stored in the ingress packet processing look-up table 127 to thereby make the forwarding decision for the received ingress packet. Once the forwarding decision making is done, the ingress packet processor 123_2 writes the received ingress packet into one or both of the TM circuits 116 and 126, depending upon the actual design. Since the ingress packet processing circuits 112 and 122 have the same function due to that fact that the first die 102 and the second die 104 are identical dies, further description of the ingress packet processing circuit 122 is omitted here for brevity.

The egress packet processing circuit 114 is used to generate egress packets to be forwarded to the egress ports TX0-TX3 of the first die 102. In this embodiment, the egress packet processor 115_1 is used to generate egress packets to be forwarded to two egress ports TX0 and TX1 of the first die 102, and the egress packet processor 115_2 is used to generate egress packets to be forwarded to two egress ports TX2 and TX3 of the first die 102. The egress packet processors 115_1 and 115_2 have the same egress packet processing functions.

For example, when a packet is decided to be forwarded to one or both of the egress ports TX0 and TX1 of the first die 102, the egress packet processor 115_1 retrieves the packet from the TM circuit 116 (if the packet is available in one packet buffer of the TM circuit 116) or retrieves the packet from the TM circuit 126 via the interconnection network 106 (if the packet is available in one packet buffer of the TM circuit 126), and checks a packet header of the retrieved packet with pre-defined rules (e.g., firewall rules) stored in the egress packet processing look-up table 118 to control forwarding of the retrieved packet. For another example, when a packet is decided to be forwarded to one or both of the egress ports TX2 and TX3 of the first die 102, the egress packet processor 115_2 retrieves the packet from the TM circuit 116 (if the packet is available in one packet buffer of the TM circuit 116) or retrieves the packet from the TM circuit 126 via the interconnection network 106 (if the packet is available in the TM circuit 126).

Similarly, the egress packet processing circuit 124 is used to generate egress packets to be forwarded to the egress ports TX0-TX3 of the second die 104. In this embodiment, the egress packet processor 125_1 is used to generate egress packets to be forwarded to two egress ports TX0 and TX1 of the second die 104, and the egress packet processor 125_2 is used to generate egress packets to be forwarded to two egress ports TX2 and TX3 of the second die 104. Since the egress packet processing circuits 114 and 124 have the same function due to that fact that the first die 102 and the second die 104 are identical dies, further description of the ingress packet processing circuit 124 is omitted here for brevity.

In some exemplary embodiments, the TM circuits 116 and 126 can be configured to do the packet replications for egress ports when an ingress packet is a multicast packet. In some exemplary embodiments, the interconnection network 106 further provides interconnection paths between the TM circuits 116 and 126 for ingress/egress accounting and/or buffer usage status synchronization. However, these are for illustrative purposes only, and are not meant to be limitations of the present invention.

With regard to the embodiment shown in FIG. 1, each die can support 4 ingress/egress ports, such that the packaged network switch IC having two identical dies can support 8 ingress/egress ports. Assume that each shortest packet needs one table look-up operation of the ingress packet processing look-up table 117/127 and one table look-up operation of the egress packet processing look-up table 118/128 to ensure the maximum packet processing speed (PPS) of 4 packets per clock cycle. To achieve this requirement, each of ingress packet processing look-up tables 117, 127 and egress packet processing look-up tables 118, 128 needs to be capable of providing 4 reads per clock cycle as there are four ingress/egress ports per die. In this embodiment, each of ingress packet processing look-up tables 117 and 127 may be implemented using a single 4-port memory device configured to store X table entries and perform at most 4 reads per clock cycle. However, using a single 4-port memory device (which can offer 4 reads per clock cycle) may not be cost-efficient and area-efficient. In this embodiment, multiple memory devices, each capable of providing at most 2 reads per clock cycle, can be used to construct a memory device with 4 reads per clock cycle.

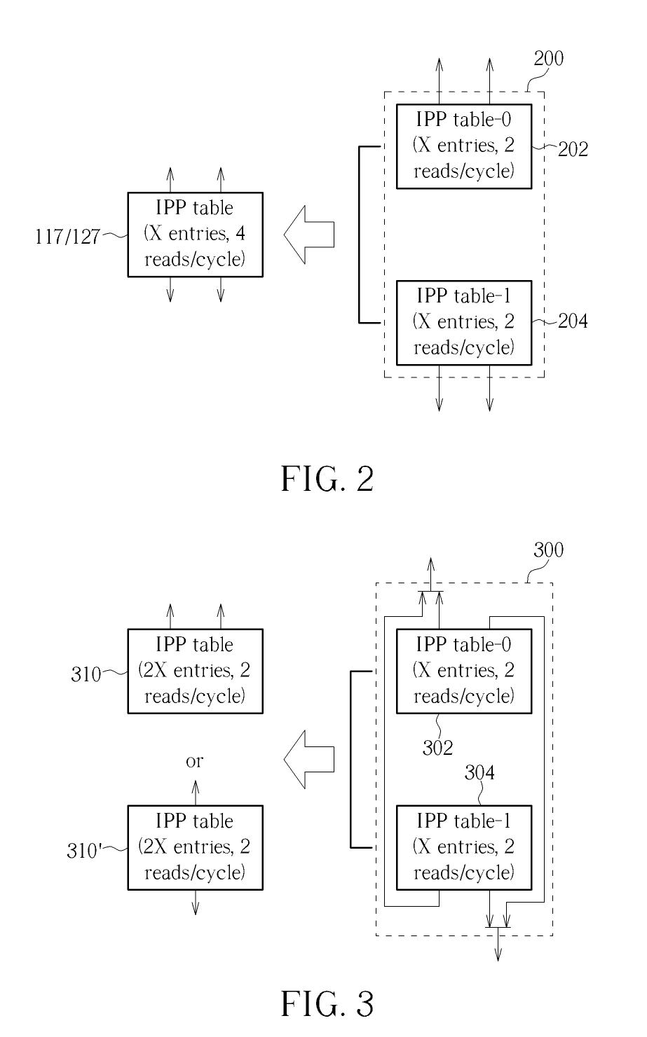

FIG. 2 is a diagram illustrating a first ingress packet processing look-up table according to an embodiment of the present invention. For example, the ingress packet processing look-up table 117/127 shown in FIG. 1 may be implemented using the ingress packet processing look-up table 200 shown in FIG. 2. In this embodiment, the ingress packet processing look-up table 200 is arranged to perform at most 4 reads per clock cycle, and includes two memory devices 202 and 204 serving as two identical ingress packet processing look-up tables denoted by “IPP table-0” and “IPP table-1”. Each of the memory devices 202 and 204 is arranged to store X table entries and perform at most 2 reads per clock cycle. It should be noted that the same table content is stored in each of the memory devices 202 and 204. That is, the table content stored in the X table entries of the memory 202 is cloned to the memory 204, such that the same table content is stored in the X table entries of the memory 204. The ingress packet processing look-up table 200 allows the same target table entry content to be read by the ingress packet processing of 4 ingress packets during the same clock cycle.

For example, the same target table entry content is available in both of the memory devices 202 and 204 due the fact that the same table content is stored in each of the memory devices 202 and 204. Hence, when the ingress packet processor 113_1 needs to read a target table entry content in a target table entry of the ingress packet processing look-up table 200 for both of an ingress packet received from the ingress port RX0 and an ingress packet received from the ingress port RX0 and the ingress packet processor 113_2 needs to read the same target table entry content in the target table entry of the ingress packet processing look-up table 200 for both of an ingress packet received from the ingress port RX2 and an ingress packet received from the ingress port RX3, the memory device 202 can perform 2 reads of the same target table entry content in the target table entry during a clock cycle for serving the table look-up requests issued from the ingress packet processor 113_1, and the memory device 204 can perform 2 reads of the same target table entry content in the target table entry during the same clock cycle for serving the table look-up requests issued from the ingress packet processor 113_2.

In this way, the ingress packet processing look-up table 200 (which is implemented using two memory devices 202 and 204, each arranged to store the same table content and perform at most 2 reads per clock cycle) can be used to perform at most 4 reads per clock cycle. Since the size and cost of two 2-port memory devices is much lower than that of a single 4 port-memory device, the size and cost of a network switch using the ingress packet processing look-up tables 200 shown in FIG. 2 can be greatly reduced.

However, if a reduced packet processing speed is allowed, the ingress packet processing look-up table 200 shown in FIG. 2 can be configured to have a larger table size by providing more table entries to build one look-up table. For example, when the network switch 100 is configured to support 2 ingress/egress ports per die or support 50% of the maximum packet processing speed per die, the ingress packet processing look-up tables 117 and 127 implemented using the ingress packet processing look-up tables 200 shown in FIG. 2 can be configured to support at most 2 reads per clock cycle under a doubled table size.

FIG. 3 is a diagram illustrating a second ingress packet processing look-up table according to an embodiment of the present invention. For example, the ingress packet processing look-up table 117/127 shown in FIG. 1 may be implemented using the ingress packet processing look-up table 300 shown in FIG. 3. In this embodiment, the ingress packet processing look-up table 300 is arranged to perform at most 2 reads per clock cycle, and includes two memory devices 302 and 304 serving as two different parts (denoted by “IPP table-0” and “IPP table-1”) of one look-up table. Each of the memory devices 302 and 304 is arranged to store X table entries and perform at most 2 reads per clock cycle. It should be noted that different table contents are stored in the memory devices 302 and 304, respectively. That is, the table content stored in the X table entries of the memory 304 is not a duplicate of the table content stored in the X table entries of the memory 302. Hence, compared to the ingress packet processing look-up table 200 with a small-sized table content stored in X table entries, the ingress packet processing look-up table 300 has a large-sized table content stored in 2X table entries. In one exemplary design, the ingress packet processing look-up table 300 may be built by storing different table contents (i.e., different parts of one look-up table) into the memory devices 302 and 304, respectively. Compared to the ingress packet processing look-up table 200, the ingress packet processing look-up table 300 provides 50% of the read bandwidth but has a doubled table size.

The ingress packet processing look-up table 300 allows the same target table entry content to be read by the ingress packet processing of 2 ingress packets during the same clock cycle. For example, the target table entry content is available in only one of the memory devices 302 and 304 due the fact that different table contents (i.e., different parts of one look-up table) are stored in the memory devices 302 and 304, respectively. Hence, in a case where an ingress packet processor needs to read a target table entry content in a target table entry of the ingress packet processing look-up table 300 for two ingress packets received from two ingress ports, the memory device 302 can perform 2 reads of the same target table entry content in the target table entry during one clock cycle for serving the table look-up requests issued from the same ingress packet processor. In this way, the ingress packet processing look-up table 300 may be regarded as an ingress packet processing look-up table 310 having 2X table entries and at most 2 reads per clock cycle in a die, and can be accessible to one ingress packet processor in the same die for 2 reads during one clock cycle.

In another case where one ingress packet processor needs to read a target table entry content in a target table entry of the ingress packet processing look-up table 300 for one ingress packet received from one ingress port and another ingress packet processor also needs to read the same target table entry content in the target table entry of the ingress packet processing look-up table 300 for one ingress packet received from one ingress port, the memory device 302 can perform 2 reads of the same target table entry content in the target table entry during one clock cycle for serving the table look-up requests issued from two ingress packet processors. In this way, the ingress packet processing look-up table 300 may be regarded as an ingress packet processing look-up table 310′ having 2X table entries and at most 2 reads per clock cycle in a die, and can be accessible to two ingress packet processors in the same die for 2 reads during one clock cycle.

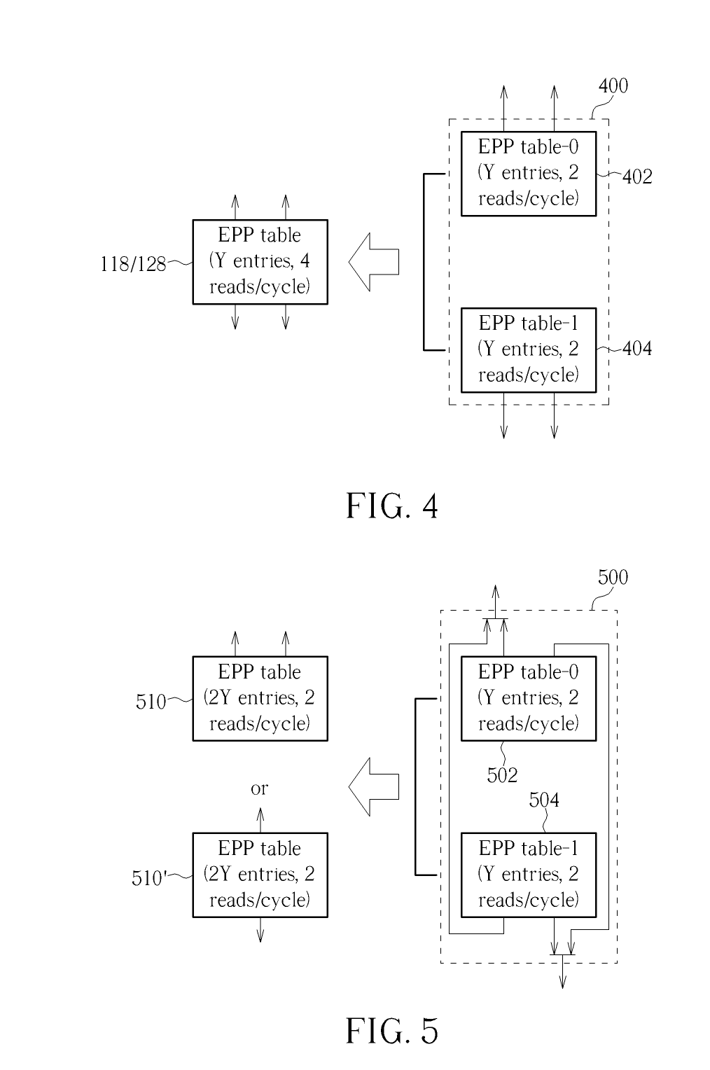

The same table design concepts illustrated in FIG. 2 and FIG. 3 can be applied to the egress packet processing look-up tables. FIG. 4 is a diagram illustrating a first egress packet processing look-up table according to an embodiment of the present invention. For example, the egress packet processing look-up tables 118 and 128 shown in FIG. 1 may be implemented using the egress packet processing look-up tables 400 shown in FIG. 4. In this embodiment, the egress packet processing look-up table 400 is arranged to perform at most 4 reads per clock cycle, and includes two memory devices 402 and 404 serving as two identical ingress packet processing look-up tables denoted by “EPP table-0” and “EPP table-1”. Each of the memory devices 402 and 404 is arranged to store X table entries and perform at most 2 reads per clock cycle. It should be noted that the same table content is stored in each of the memory devices 402 and 404. That is, the table content stored in the X table entries of the memory 402 is cloned to the memory 404, such that the same table content is stored in the X table entries of the memory 404. The ingress packet processing look-up table 400 allows the same target table entry content to be read by the ingress packet processing of 4 ingress packets during the same clock cycle. As a person skilled in the art can readily understand details of the egress packet processing look-up table 400 shown in FIG. 4 after reading above paragraphs directed to the ingress packet processing look-up table 200 shown in FIG. 2, further description is omitted here for brevity.

FIG. 5 is a diagram illustrating a second egress packet processing look-up table according to an embodiment of the present invention. For example, the ingress packet processing look-up tables 118 and 128 shown in FIG. 1 may be implemented using the egress packet processing look-up tables 500 shown in FIG. 5. In this embodiment, the egress packet processing look-up table 500 is arranged to perform at most 2 reads per clock cycle, and includes two memory devices 502 and 504 serving as two different parts (denoted by “EPP table-0” and “EPP table-1”) of one look-up table. Each of the memory devices 502 and 504 is arranged to store X table entries and perform at most 2 reads per clock cycle. It should be noted that different table contents (i.e., different parts of one look-up table) are stored in the memory devices 502 and 504, respectively. That is, the table content stored in the X table entries of the memory 504 is not a duplicate of the table content stored in the X table entries of the memory 502. Hence, compared to the egress packet processing look-up table 400 with a small-sized table content stored in X table entries, the egress packet processing look-up table 500 has a large-sized table content stored in 2X table entries.

In one exemplary design, the egress packet processing look-up table 500 may be built by storing different table contents (i.e., different parts of one look-up table) into the memory devices 402 and 404, respectively. Compared to the ingress packet processing look-up table 400, the ingress packet processing look-up table 500 provides 50% of the read bandwidth but has a doubled table size. The egress packet processing look-up table 500 in a die may be regarded as an ingress packet processing look-up table 510 having 2X table entries and at most 2 reads per clock cycle, and can be accessible to one ingress packet processor in the same die for 2 reads during one clock cycle, or may be regarded as an ingress packet processing look-up table 510′ having 2X table entries and at most 2 reads per clock cycle, and can be accessible to two ingress packet processors in the same die for 2 reads during one clock cycle.

In one exemplary embodiment, ingress packet processing look-up tables 117, 127 can be implemented using the memory construction shown in FIG. 2, and egress packet processing look-up tables 118 and 128 can be implemented using the memory construction shown in FIG. 4. It should be noted that, concerning such an exemplary network switch design shown in FIG. 1, the number of ingress ports in each identical die, the number of egress ports in each identical die, the number of identical dies in the same package, the number of ingress packet processors in each identical die, and the number of egress packet processors in each identical die are for illustrative purposes only, and are not meant to be limitations of the present invention. The design of the exemplary network switch in FIG. 1 with the use of the exemplary memory constructions in FIG. 2 and FIG. 4 can be briefly summarized as below. Suppose that the number of ingress/egress ports per die is M. All of the M ingress/egress ports are enabled when a network switch is in operation. Each ingress/egress packet processing circuit includes an ingress/egress packet processing look-up table arranged to perform at most M reads per clock cycle. The ingress/egress packet processing look-up table includes N memory devices, each storing a plurality of table entries and arranged to perform at most Q reads per clock cycle, where M, N and Q are integer numbers, Q is equal to

$$\frac{M}{N} ,$$

and the same table content is stored in each of the N memory devices.

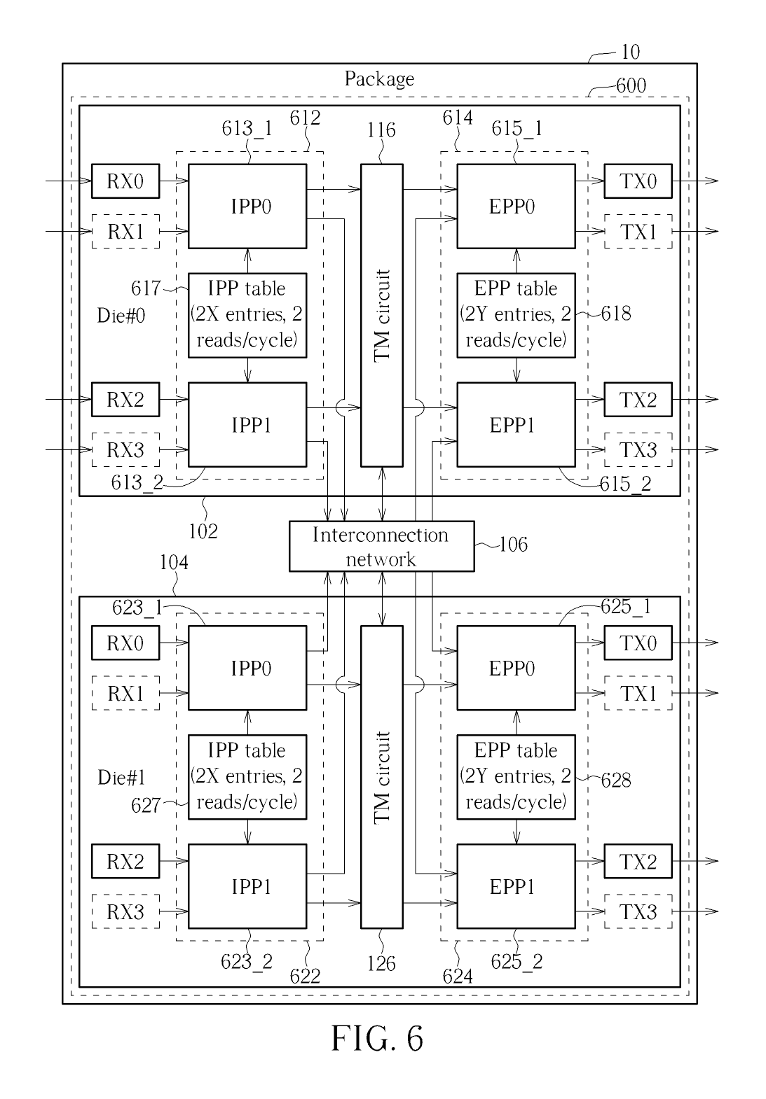

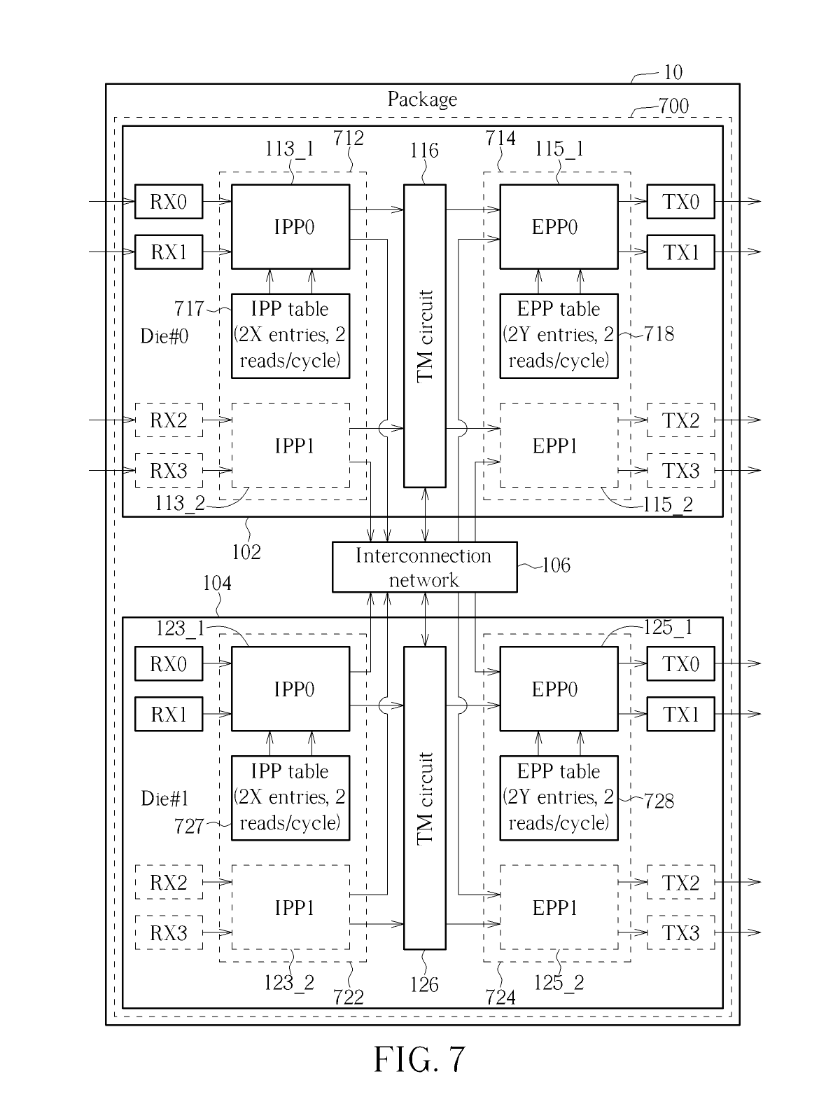

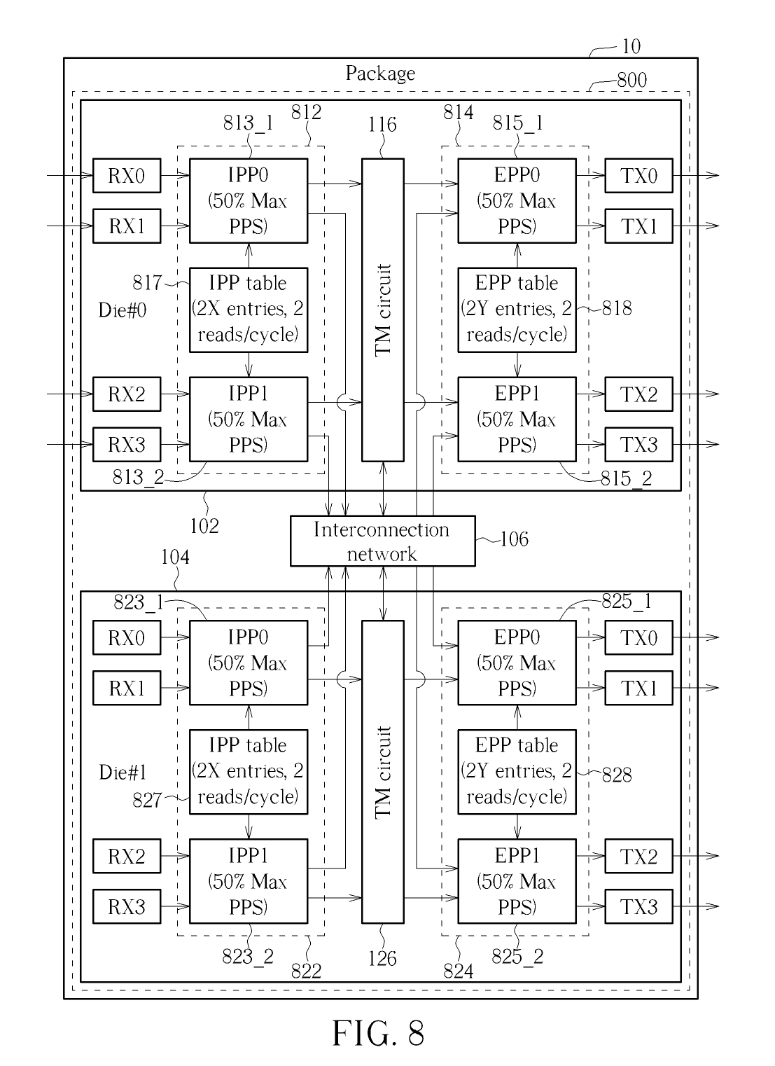

Further, based on the memory constructions shown in FIG. 3 and FIG. 5, the network switch 100 in FIG. 1 with the use of the exemplary memory constructions in FIG. 2 and FIG. 4 can be modified to produce several variants of the network switch product. In other words, based on the actual network switch product requirements, one network switch IC can be configured/programmed to be a network switch in FIG. 1 with the use of the exemplary memory constructions in FIG. 2 and FIG. 4, a network switch in FIG. 6 with the use of the exemplary memory constructions in FIG. 3 and FIG. 5, a network switch in FIG. 7 with the use of the exemplary memory constructions in FIG. 3 and FIG. 5, or a network switch in FIG. 8 with the use of the exemplary memory constructions in FIG. 3 and FIG. 5. Further description of the alternative network switch designs is detailed as below.

FIG. 6 is a diagram illustrating a second network switch according to an embodiment of the present invention. The network switch 600 employs the ingress packet processing look-up tables 300 shown in FIG. 3 and the egress packet processing look-up tables 500 shown in FIG. 5. When the network switch 600 is in operation, only half of the ingress ports RX0-RX3 of the first die 102 are enabled, only half of the egress ports TX0-TX3 of the first die 102 are enabled, only half of the ingress ports RX0-RX3 of the second die 104 are enabled, and only half of the egress ports TX0-TX3 of the second die 104 are enabled. Hence, the network switch 600 is configured to trade off the port count (e.g., from 8 ingress/egress ports to 4 ingress/egress ports) and the ingress/egress packet processing look-up table size (e.g., from X/Y table entries to 2X/2Y table entries).

In this embodiment, when the network switch 600 is in operation, the ingress port RX0 of the ingress ports RX0 and RX1 both coupled to the ingress packet processor 613_1 of the ingress packet processing circuit 612 in the first die 102 is enabled, the ingress port RX1 of the ingress ports RX0 and RX1 both coupled to the ingress packet processor 613_1 of the ingress packet processing circuit 612 in the first die 102 is disabled (e.g., powered down), the ingress port RX2 of the ingress ports RX2 and RX3 both coupled to the ingress packet processor 613_2 of the ingress packet processing circuit 612 in the first die 102 is enabled, the ingress port RX3 of the ingress ports RX2 and RX3 both coupled to the ingress packet processor 613_2 of the ingress packet processing circuit 612 in the first die 102 is disabled (e.g., powered down), the egress port TX0 of the egress ports TX0 and TX1 both coupled to the egress packet processor 615_1 of the egress packet processing circuit 614 in the first die 102 is enabled, the egress port TX1 of the egress ports TX0 and TX1 both coupled to the egress packet processor 615_1 of the egress packet processing circuit 614 in the first die 102 is disabled (e.g., powered down), the egress port TX2 of the egress ports TX2 and TX3 both coupled to the egress packet processor 615_2 of the egress packet processing circuit 614 in the first die 102 is enabled, and the egress port TX2 of the egress ports TX2 and TX3 both coupled to the ingress packet processor 615_2 of the ingress packet processing circuit 614 in the first die 102 is disabled (e.g., powered down).

In one exemplary embodiment, since each of the ingress packet processors 613_1 and 613_2 in the first die 102 is required to deal with ingress packets received from one ingress port instead of ingress packets received from two ingress ports, the clock speed of each of the ingress packet processors 613_1 and 613_2 can be lower than (e.g., half of) the clock speed of each of the ingress packet processors 613_1 and 613_2 that are configured to operate under a case where the ingress ports RX0-RX4 in the first die 102 are all enabled. Similarly, since each of the egress packet processors 615_1 and 615_2 in the first die 102 is required to deal with egress packets transmitted to one egress port instead of egress packets transmitted to two egress ports, the clock speed of each of the egress packet processors 615_1 and 615_2 can be lower than (e.g., half of) the clock speed of each of the egress packet processors 615_1 and 615_2 that are configured to operate under a case where the egress ports TX0-TX4 in the first die 102 are all enabled.

In another exemplary embodiment, since each of the ingress packet processors 613_1 and 613_2 in the first die 102 is required to deal with ingress packets received from one ingress port instead of ingress packets received from two ingress ports, the supply voltage level of each of the ingress packet processors 613_1 and 613_2 can be lower than (e.g., half of) the supply voltage level of each of the ingress packet processors 613_1 and 613_2 that are configured to operate under a case where the ingress ports RX0-RX4 in the first die 102 are all enabled. Similarly, since each of the egress packet processors 615_1 and 615_2 in the first die 102 is required to deal with egress packets transmitted to one egress port instead of egress packets transmitted to two egress ports, the supply voltage level of each of the egress packet processors 615_1 and 615_2 can be lower than (e.g., half of) the supply voltage level of each of the egress packet processors 615_1 and 615_2 that are configured to operate under a case where the egress ports TX0-TX4 in the first die 102 are all enabled.

Further, when the network switch 600 is in operation, the ingress port RX0 of the ingress ports RX0 and RX1 both coupled to the ingress packet processor 623_1 of the ingress packet processing circuit 622 in the second die 104 is enabled, the ingress port RX1 of the ingress ports RX0 and RX1 both coupled to the ingress packet processor 623_1 of the ingress packet processing circuit 622 in the second die 104 is disabled (e.g., powered down), the ingress port RX2 of the ingress ports RX2 and RX3 both coupled to the ingress packet processor 623_2 of the ingress packet processing circuit 622 in the second die 104 is enabled, the ingress port RX3 of the ingress ports RX2 and RX3 both coupled to the ingress packet processor 623_2 of the ingress packet processing circuit 622 in the second die 104 is disabled (e.g., powered down), the egress port TX0 of the egress ports TX0 and TX1 both coupled to the egress packet processor 625_1 of the egress packet processing circuit 624 in the second die 104 is enabled, the egress port TX1 of the egress ports TX0 and TX1 both coupled to the egress packet processor 625_1 of the egress packet processing circuit 624 in the second die 104 is disabled (e.g., powered down), the egress port TX2 of the egress ports TX2 and TX3 both coupled to the egress packet processor 625_2 of the egress packet processing circuit 624 in the second die 104 is enabled, and the egress port TX2 of the egress ports TX2 and TX3 both coupled to the ingress packet processor 625_2 of the egress packet processing circuit 624 in the second die 104 is disabled (e.g., powered down).

Similarly, the clock speed of each of the ingress packet processors 623_1 and 623_2 can be lower than (e.g., half of) the clock speed of each of the ingress packet processors 623_1 and 623_2 that are configured to operate under a case where the ingress ports RX0-RX4 in the second die 104 are all enabled, and the clock speed of each of the egress packet processors 625_1 and 625_2 can be lower than (e.g., half of) the clock speed of each of the egress packet processors 625_1 and 625_2 that are configured to operate under a case where the egress ports TX0-TX4 in the second die 104 are all enabled. The supply voltage level of each of the ingress packet processors 623_1 and 623_2 can be lower than (e.g., half of) the supply voltage level of each of the ingress packet processors 623_1 and 623_2 that are configured to operate under a case where the ingress ports RX0-RX4 in the second die 104 are all enabled, and the supply voltage level of each of the egress packet processors 625_1 and 625_2 can be lower than (e.g., half of) the supply voltage level of each of the egress packet processors 625_1 and 625_2 that are configured to operate under a case where the egress ports TX0-TX4 in the second die 104 are all enabled.

The power of a circuit is proportional to CLK*VDD̂2, where CLK is the clock speed of the circuit and VDD is the supply voltage level of the circuit. Hence, the overall system power of the network switch 600 can be reduced significantly when one or both of the clock speed and the supply voltage level of each packet processing processor is reduced.

It should be noted that, concerning such an exemplary network switch design shown in FIG. 6, the number of ingress ports in each identical die, the number of egress ports in each identical die, the number of identical dies in the same package, the number of ingress packet processors in each identical die, and the number of egress packet processors in each identical die are for illustrative purposes only, and are not meant to be limitations of the present invention. The design of the exemplary network switch in FIG. 6 with the use of the exemplary memory constructions in FIG. 3 and FIG. 5 can be briefly summarized as below. Suppose that the number of ingress/egress ports per die is M. An ingress/egress packet processing circuit of a network switch includes an ingress/egress packet processing look-up table arranged to perform at most K reads per clock cycle, and further includes P ingress/egress packet processors each coupled to R ingress/egress ports. When the network switch is in operation, all of the P ingress/egress packet processors are enabled, only S ingress/egress ports of the R ingress/egress ports coupled to each of the P ingress/egress packet processors are enabled, and only K ingress/egress ports of the M ingress/egress ports are enabled. The ingress/egress packet processing look-up table includes N memory devices, each storing a plurality of table entries and arranged to perform at most K reads per clock cycle, where M, N, P, R, S and K are integer numbers, K is smaller than M, R is equal to

$$\frac{M}{P} ,$$

S is equal to

$$\frac{K}{P} ,$$

and different table contents are stored in the N memory devices, respectively. In one exemplary design, a clock speed/supply voltage level of each of the P ingress/egress packet processors is lower than a clock speed/supply voltage level of each of the P ingress/egress packet processors that are configured to operate under a case where the M ingress/egress ports are all enabled.

FIG. 7 is a diagram illustrating a third network switch according to an embodiment of the present invention. The network switch 700 employs the ingress packet processing look-up tables 300 shown in FIG. 3 and the egress packet processing look-up tables 500 shown in FIG. 5. When the network switch 700 is in operation, only half of the ingress packet processors 113_1 and 113_2 of the first die 102 are enabled, only half of the egress packet processors 115_1 and 115_2 of the first die 102 are enabled, only half of the ingress packet processors 123_1 and 123_2 of the second die 104 are enabled, and only half of the egress packet processors 125_1 and 125_2 of the second die 104 are enabled. Further, only half of the ingress ports RX0-RX3 of the first die 102 are enabled, only half of the egress ports TX0-TX3 of the first die 102 are enabled, only half of the ingress ports RX0-RX3 of the second die 104 are enabled, and only half of the egress ports TX0-TX3 of the second die 104 are enabled. Hence, the network switch 700 is configured to trade off the port count (e.g., from 8 ingress/egress ports to 4 ingress/egress ports) and the ingress/egress packet processing look-up table size (e.g., from X/Y table entries to 2X/2Y table entries).

In this embodiment, when the network switch 700 is in operation, the ingress packet processor 113_1 of the ingress packet processing circuit 712 and all associated ingress ports RX0 and RX1 in the first die 102 are enabled, the ingress packet processor 113_2 of the ingress packet processing circuit 712 and all associated ingress ports RX2 and RX3 in the first die 102 are disabled (e.g., powered down), the egress packet processor 115_1 of the egress packet processing circuit 714 and all associated egress ports TX0 and TX1 in the first die 102 are enabled, and the egress packet processor 115_2 of the egress packet processing circuit 714 and all associated egress ports TX2 and TX3 in the first die 102 are disabled (e.g., powered down). It should be noted that the active ingress packet processor 113_1 and egress packet processor 115_1 still run at the full clock speed. That is, the clock speed of the ingress packet processor 113_1 shown in FIG. 7 is the same as the clock speed of the ingress packet processor 113_1 that is configured to operate under a case where the ingress ports RX0-RX4 and the ingress packet processors 113_1 and 113_2 in the first die 102 are all enabled, and the clock speed of the egress packet processor 115_1 shown in FIG. 7 is the same as the clock speed of the egress packet processor 115_1 that is configured to operate under a case where the egress ports TX0-TX4 and the egress packet processors 115_1 and 115_2 in the first die 102 are all enabled.

Further, when the network switch 700 is in operation, the ingress packet processor 123_1 of the ingress packet processing circuit 722 and all associated ingress ports RX0 and RX1 in the second die 104 are enabled, the ingress packet processor 123_2 of the ingress packet processing circuit 722 and all associated ingress ports RX2 and RX3 in the second die 104 are disabled (e.g., powered down), the egress packet processor 125_1 of the egress packet processing circuit 724 and all associated egress ports TX0 and TX1 in the second die 104 are enabled, and the egress packet processor 125_2 of the egress packet processing circuit 724 and all associated egress ports TX2 and TX3 in the second die 104 are disabled (e.g., powered down). It should be noted that the active ingress packet processor 123_1 and egress packet processor 125_1 still run at the full clock speed. That is, the clock speed of the ingress packet processor 123_1 shown in FIG. 7 is the same as the clock speed of the ingress packet processor 123_1 that is configured to operate under a case where the ingress ports RX0-RX4 and the ingress packet processors 123_1 and 123_2 in the second die 104 are all enabled, and the clock speed of the egress packet processor 125_1 shown in FIG. 7 is the same as the clock speed of the egress packet processor 125_1 that is configured to operate under a case where the egress ports TX0-TX4 and the egress packet processors 125_1 and 125_2 in the second die 104 are all enabled.

Since only half of the ingress packet processors and only half of the egress packet processors are enabled, the overall system power of the network switch 700 can be reduced.

It should be noted that, concerning such an exemplary network switch design shown in FIG. 7, the number of ingress ports in each identical die, the number of egress ports in each identical die, the number of identical dies in the same package, the number of ingress packet processors in each identical die, and the number of egress packet processors in each identical die are for illustrative purposes only, and are not meant to be limitations of the present invention. The design of the exemplary network switch in FIG. 7 with the use of the exemplary memory constructions in FIG. 3 and FIG. 5 can be briefly summarized as below. Suppose that the number of ingress/egress ports per die is M. An ingress/egress packet processing circuit of a network switch includes an ingress/egress packet processing look-up table arranged to perform at most K reads per clock cycle, and further includes P ingress/egress packet processors each coupled to R ingress/egress ports. When the network switch is in operation, only K ingress/egress ports of the M ingress/egress ports are enabled, only S ingress/egress packet processors of the P ingress/egress packet processors are enabled, and all of the R ingress/egress ports coupled to each of the S ingress/egress packet processors are enabled. The ingress/egress packet processing look-up table includes N memory devices, each storing a plurality of table entries and arranged to perform at most K reads per clock cycle, wherein M, N, P, R, S and K are integer numbers, K is smaller than M, R is equal to M/P, S is smaller than P, S*R is equal to K, and different table contents are stored in the N memory devices, respectively.

FIG. 8 is a diagram illustrating a fourth network switch according to an embodiment of the present invention. The network switch 800 employs the ingress packet processing look-up tables 300 shown in FIG. 3 and the egress packet processing look-up tables 500 shown in FIG. 5. When the network switch 800 is in operation, the ingress packet processors 813_1 and 813_2 of the ingress packet processing circuit 812 and all associated ingress ports RX0-RX3 in the first die 102 are enabled, the egress packet processors 815_1 and 815_2 of the egress packet processing circuit 814 and all associated egress ports TX0-TX3 in the first die 102 are enabled, the ingress packet processors 823_1 and 823_2 of the ingress packet processing circuit 822 and all associated ingress ports RX0-RX3 in the second die 104 are enabled, and the egress packet processors 825_1 and 825_2 of the egress packet processing circuit 824 and all associated egress ports TX0-TX3 in the second die 104 are enabled.

However, each of ingress packet processors 813_1, 813_2, 823_1, 823_2 and egress packet processors 815_1, 815_2, 825_1, 825_2 is configured to operate at a slower packet processing speed (PPS). That is, the packet processing speed of each of the ingress packet processors 813_1, 813_2, 823_1, 823_2 shown in FIG. 8 is configured to be lower than the maximum packet processing speed supported by each of the ingress packet processors 813_1, 813_2, 823_1, 823_2, and the packet processing speed of each of the egress packet processors 815_1, 815_2, 825_1, 825_2 shown in FIG. 8 is configured to be lower than the maximum packet processing speed supported by each of the egress packet processors 815_1, 815_2, 825_1, 825_2. Hence, the network switch 800 is configured to trade off the packet processing speed (e.g., from the maximum packet processing speed to 50% of the maximum packet processing speed) and the ingress/egress packet processing look-up table size (e.g., from X/Y table entries to 2X/2Y table entries).

In this case, the network switch 800 may not support the wire-speed performance for back-to-back packets each having the smallest packet size due to the reduced memory bandwidth from 4 reads per clock cycle to 2 reads per clock cycle. As these back-to-back shortest packet bursts are not common in a real application and the network switch 800 can be designed to have some small-sized buffers (not shown) to absorb the shortest packet bursts before the shortest packet bursts arrive at the ingress packet processors 813_1, 813_2, 823_1, 823_2, the network switch 800 without port count reduction is still attractive. Further, since each of ingress packet processors and egress packet processors is configured to operate at a slower packet processing speed (e.g., 50% of the supported maximum packet processing speed), the overall system power of the network switch 800 can be reduced.

It should be noted that, concerning such an exemplary network switch design shown in FIG. 8, the number of ingress ports in each identical die, the number of egress ports in each identical die, the number of identical dies in the same package, the number of ingress packet processors in each identical die, and the number of egress packet processors in each identical die are for illustrative purposes only, and are not meant to be limitations of the present invention. The design of the exemplary network switch in FIG. 8 with the use of the exemplary memory constructions in FIG. 3 and FIG. 5 can be briefly summarized as below. Suppose that the number of ingress/egress ports per die is M. An ingress/egress packet processing circuit of a network switch includes an ingress/egress packet processing look-up table arranged to perform at most Q reads per clock cycle, and further includes P ingress/egress packet processors each coupled to R ingress/egress ports. When the network switch is in operation, all of the M ingress/egress ports are enabled, all of the P ingress/egress packet processors are enabled, and all of the R ingress ports coupled to each of the P ingress/egress packet processors are enabled, where M, N, P, R, and Q are integer numbers, Q is smaller than M, a packet processing speed of each of the P ingress/egress packet processors is configured to be lower than a maximum packet processing speed supported by each of the P ingress/egress packet processors, and different table contents are stored in the N memory devices, respectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network switch comprising:
a plurality of identical dies, packaged in a package, wherein the identical dies comprise at least a first die and a second die, each comprising:
a plurality of ingress ports, arranged to receive ingress packets;
an ingress packet processing circuit, arranged to process the ingress packets; and
a traffic manager circuit, arranged to store packets processed by ingress packet processing circuits of the first die and the second die; and
an interconnection network, packaged in the package, wherein the interconnection network is arranged to transmit an output of the ingress packet processing circuit in the first die to the traffic manager circuit of the second die, and transmit an output of the ingress packet processing circuit of the second die to the traffic manager circuit of the first die.

2. The network switch of claim 1, wherein the package is a wafer-level package.

3. The network switch of claim 2, wherein the wafer-level package is an integrated fan-out (InFO) package or a chip on wafer on substrate (CoWoS) package.

4. The network switch of claim 1, wherein a number of the ingress ports is M, all of the M ingress ports are enabled when the network switch is in operation, and the ingress packet processing circuit comprises:
an ingress packet processing look-up table, arranged to perform at most M reads per clock cycle, the ingress packet processing look-up table comprising:
N memory devices, each storing a plurality of table entries and arranged to perform at most Q reads per clock cycle, wherein M, N and Q are integer numbers, Q is equal to
$$\frac{M}{N} ,$$
and a same table content is stored in each of the N memory devices.

5. The network switch of claim 1, wherein a number of the ingress ports is M, only K ingress ports of the M ingress ports are enabled when the network switch is in operation, and the ingress packet processing circuit comprises:
an ingress packet processing look-up table, arranged to perform at most K reads per clock cycle, the ingress packet processing look-up table comprising:
N memory devices, each storing a plurality of table entries and arranged to perform at most K reads per clock cycle, wherein M, N and K are integer numbers, K is smaller than M, and different table contents are stored in the N memory devices, respectively.

6. The network switch of claim 5, wherein the ingress packet processing circuit further comprises:
P ingress packet processors, each coupled to R ingress ports;
wherein when the network switch is in operation, all of the P ingress packet processors are enabled, only S ingress ports of the R ingress ports coupled to each of the P ingress packet processors are enabled, and a clock speed of each of the P ingress packet processors is lower than a clock speed of each of the P ingress packet processors that are configured to operate under a case where the M ingress ports are all enabled, where P, R, and S are integer numbers, R is equal to
$$\frac{M}{P} ,$$
and S is equal to
$$\frac{K}{P} .$$

7. The network switch of claim 5, wherein the ingress packet processing circuit further comprises:
P ingress packet processors, each coupled to R ingress ports;
wherein when the network switch is in operation, all of the P ingress packet processors are enabled, only S ingress ports of the R ingress ports coupled to each of the P ingress packet processors are enabled, and a supply voltage level of each of the P ingress packet processors is lower than a supply voltage level of each of the P ingress packet processors that are configured to operate under a case where the M ingress ports are all enabled, where P, R, and S are integer numbers, R is equal to
$$\frac{M}{P} ,$$
and S is equal to
$$\frac{K}{P} .$$

8. The network switch of claim 5, wherein the ingress packet processing circuit further comprises:
P ingress packet processors, each coupled to R ingress ports;
wherein when the network switch is in operation, only S ingress packet processors of the P ingress packet processors are enabled, and all of the R ingress ports coupled to each of the S ingress packet processors are enabled, where P, R, and S are integer numbers, R is equal to
$$\frac{M}{P} ,$$
S is smaller than P, and S*R is equal to K.

9. The network switch of claim 1, wherein a number of the ingress ports is M, all of the M ingress ports are enabled when the network switch is in operation, and the ingress packet processing circuit comprises:
an ingress packet processing look-up table, arranged to perform at most Q reads per clock cycle, the ingress packet processing look-up table comprising:
N memory devices, each storing a plurality of table entries and arranged to perform at most Q reads per clock cycle, wherein M, N, and Q are integer numbers, Q is smaller than M, and different table contents are stored in the N memory devices, respectively.

10. The network switch of claim 9, wherein the ingress packet processing circuit further comprises:
P ingress packet processors, each coupled to R ingress ports;
wherein when the network switch is in operation, all of the P ingress packet processors are enabled, all of the R ingress ports coupled to each of the P ingress packet processors are enabled, and a packet processing speed of each of the P ingress packet processors is configured to be lower than a maximum packet processing speed supported by each of the P ingress packet processors, where P and R are integer numbers.

11. A network switch comprising:
a plurality of identical dies, packaged in a package, wherein the identical dies comprise at least a first die and a second die, each comprising:
a plurality of egress ports, arranged to output egress packets;
an egress packet processing circuit, arranged to generate the egress packets; and
a traffic manager circuit, arranged to output stored packets to egress packet processing circuits of the first die and the second die; and
an interconnection network, packaged in the package, wherein the interconnection network is arranged to transmit an output of the traffic manager circuit of the first die to the egress packet processing circuit of the second die, and transmit an output of the traffic manager circuit of the second die to the egress packet processing circuit of the first die.

12. The network switch of claim 11, wherein the package is a wafer-level package.

13. The network switch of claim 12, wherein the wafer-level package is an integrated fan-out (InFO) package or a chip on wafer on substrate (CoWoS) package.

14. The network switch of claim 11, wherein a number of the egress ports is M, all of the M egress ports are enabled when the network switch is in operation, and the egress packet processing circuit comprises:
an egress packet processing look-up table, arranged to perform at most M reads per clock cycle, the egress packet processing look-up table comprising:
N memory devices, each storing a plurality of table entries and arranged to perform at most Q reads per clock cycle, wherein M, N and Q are integer numbers, Q is equal to
$$\frac{M}{N} ,$$
and a same table content is stored in each of the N memory devices.

15. The network switch of claim 11, wherein a number of the egress ports is M, only K egress ports of the M egress ports are enabled when the network switch is in operation, and the egress packet processing circuit comprises:
an egress packet processing look-up table, arranged to perform at most K reads per clock cycle, the egress packet processing look-up table comprising:
N memory devices, each storing a plurality of table entries and arranged to perform at most K reads per clock cycle, wherein M, N and K are integer numbers, K is smaller than M, and different table contents are stored in the N memory devices, respectively.

16. The network switch of claim 15, wherein the egress packet processing circuit further comprises:
P egress packet processors, each coupled to R egress ports;
wherein when the network switch is in operation, all of the P egress packet processors are enabled, only S egress ports of the R egress ports coupled to each of the P egress packet processors are enabled, and a clock speed of each of the P egress packet processors is lower than a clock speed of each of the P egress packet processors that are configured to operate under a case where the M egress ports are all enabled, where P, R, and S are integer numbers, R is equal to
$$\frac{M}{P} ,$$
and S is equal to
$$\frac{K}{P} .$$

17. The network switch of claim 15, wherein the egress packet processing circuit further comprises:
P egress packet processors, each coupled to R egress ports;
wherein when the network switch is in operation, all of the P egress packet processors are enabled, only S egress ports of the R egress ports coupled to each of the P egress packet processors are enabled, and a supply voltage level of each of the P egress packet processors is lower than a supply voltage level of each of the P egress packet processors that are configured to operate under a case where the M egress ports are all enabled, where R and S are integer numbers, R is equal to
$$\frac{M}{P} ,$$
and S is equal to
$$\frac{K}{P} .$$

18. The network switch of claim 15, wherein the egress packet processing circuit further comprises:
P egress packet processors, each coupled to R egress ports;
wherein when the network switch is in operation, only S egress packet processors of the P egress packet processors are enabled, and all of the R egress ports coupled to each of the S egress packet processors are enabled, where P, R, and S are integer numbers, R is equal to
$$\frac{M}{P} ,$$
S is smaller than P, and S*R is equal to K.

19. The network switch of claim 11, wherein a number of the egress ports is M, all of the M egress ports are enabled when the network switch is in operation, and the egress packet processing circuit comprises:
an egress packet processing look-up table, arranged to perform at most Q reads per clock cycle, the egress packet processing look-up table comprising:
N memory devices, each storing a plurality of table entries and arranged to perform at most Q reads per clock cycle, wherein M, N, and Q are integer numbers, Q is smaller than M, and different table contents are stored in the N memory devices, respectively.

20. The network switch of claim 19, wherein the egress packet processing circuit further comprises:
P egress packet processors, each coupled to R egress ports;
wherein when the network switch is in operation, all of the P egress packet processors are enabled, all of the R egress ports coupled to each of the P egress packet processors are enabled, and a packet processing speed of each of the P egress packet processors is configured to be lower than a maximum packet processing speed supported by each of the P egress packet processors, where P and R are integer numbers.
